(19) United States
(12) Patent Application Publication
(10) Pub. No.: US 2024/0177236 A1
(43) Pub. Date: May 30, 2024

(54) DESIGN CROWDFUNDING PLATFORM PROVISION METHOD, AND DEVICE AND SYSTEM THEREFOR

(71) Applicant: Woo Hyuck JANG, Seoul (KR)

(72) Inventor: Woo Hyuck JANG, Seoul (KR)

(21) Appl. No.: 18/283,552

(22) PCT Filed: Mar. 30, 2022
(86) PCT No.: PCT/KR2022/004497

§ 371 Date: Sep. 22, 2023

(30) Foreign Application Priority Data
Mar. 30, 2021 (KR) 10-2021-0041366

(51) Int. Cl. G06Q 40/06

(52) U.S. Cl. CPC G06Q 40/06

(57) ABSTRACT

Provided is an apparatus for providing design crowdfunding platform. The apparatus for providing design crowdfunding platform may include: a designer support module configured to register a design and start funding; and an investor support module configured to proceed with the funding started by the designer support module, and adjust the investment profit.

### TECHNICAL FIELD

The present invention relates to a method for providing design crowdfunding platform, and an apparatus and system therefor, and more particularly, to a method for providing design crowdfunding platform which allows a designer to register a design and receive crowdfunding for the development and production of design products, allows an investor to select and fund a design and receive payment of investment profit, allows a designer who have registered a design, because there being no limit on the fund-raising amount, to obtain a lot of profit, and can provide a refund opportunity even to an investor whose profit rate decreases as the fund-raising amount increases, and an apparatus and system therefor.

### BACKGROUND ART

Crowdfunding is a system in which consumers in need of funds raise funds from an unspecified number of people through online platforms. Generally, crowdfunding is a system in which a target amount is set, and thus, if the raised funds exceed a target amount, the project will succeed, and if the target amount cannot be achieved, the fund is returned to investors and the project is cancelled.

In such an existing crowdfunding system, consumers in need of funds set a target amount in advance to raise funds, which makes it difficult to obtain additional profit other than the amount necessary for the development, production, and sales of their own design products at the fund-raising stage. Therefore, there are problems that active fund-raising activities are not performed, the participation of designers having high value is inevitably low, and the evaluation of the product is performed depending on whether the target amount is achieved.

Further, in the existing crowdfunding system, there is a problem that it is difficult to provide appropriate compensation to a large number of people who provide funds, and there are systems of providing equity, dividends and the like in order to provide appropriate compensation, but this can only be used as a system of raising funds for start-up companies, and the like, and thus, there are some aspects that make it inappropriate for individuals such as designers to utilize it.

Furthermore, the existing crowdfunding system has been constructed only for a fund-raising person and a provider of funds, and accordingly, there is a problem that it is troublesome to separately search and select a product producer and find a separate route for selling the product.

Therefore, in order to solve these problems, there is a growing need to develop a method for providing design crowdfunding platform and an apparatus and system therefor, which allow not only companies but also individual designers to register their design products and raise funds, which can provide designers with surplus funds other than costs for design product development, production, and the like, because there being having no limit on the fund-raising amount, so that the designers themselves can obtain a lot of profits, which allow investors who have raised funds to provide a certain share of the profits from the sales price, thereby earning the investment profit, which can provide a refund opportunity to the existing investors whenever the profit rate decreases by a certain percentage, because there being no limit on the fund-raising amount, and which can easily provide product producers and consumers with opportunities to produce and purchase products.

### DETAILED DESCRIPTION OF THE INVENTION

### Technical Problem

The present invention has been designed to solve the above problems, and an object of the present invention is to provide a method for providing design crowdfunding platform and its device and system, in which not only companies but also individual designers can easily register design products and raise funds, and individual designers can receive provision of the surplus money other than expenses for design product development and production, and the like, because there being no limit on the fund-raising amount, thereby earning a large amount of profit.

Another object of the present invention is to provide a method for providing design crowdfunding platform and an apparatus and system therefor, in which investors can confirm a large number of registered design products and information related to the design products and invest a desired investment amount, thereby obtaining the investment profit; because there being no limit on the fund-raising amount, as the fund-raising amount is higher, the sales yield per share of the design product, i.e., the investment profit rate, is lower, thereby providing a refund opportunity to the existing investors whenever the profit rate drops to a certain numerical ratio; and as the number of investors who are judged to have a low profit rate increases, the raised amount will naturally and more slowly grow, thereby preventing an abnormally low profit rate.

Another object of the present invention is to provide a method for providing design crowdfunding platform and an apparatus and system therefor, in which the value of design can be evaluated through the fund-raised amount by a large number of investors to achieve collective intelligence in design evaluation; and the designer who created a design can make a higher profit as the money invested for the design is higher.

Yet another object of the present invention is to provide a method for providing design crowdfunding platform and an apparatus and system therefor, in which in order to avoid the inconvenience of designers having to separately search for and select producers of design products being funded, and having to find a separate sales route for design products, it is possible to connect a designer, an investor, a producer and a consumer who have raised funds through one platform, thereby allowing designers to easily expose their design products to producers and consumers, and easily providing the producer and consumer with an opportunity to produce and purchase products.

Technical solutions obtainable from the present invention are non-limited to the above-mentioned technical solutions. And, other unmentioned technical solutions can be clearly understood from the following description by those having ordinary skill in the technical field to which the present invention pertains.

### Technical Solution

In order to achieve the above object, according to one embodiment of the present invention, there can be provided an apparatus for providing design crowdfunding platform comprising: a designer support module configured to register a design and start funding; and an investor support module configured to proceed with the funding started by the designer support module, and adjust the investment profit.

Also, the designer support module may comprise a design registration unit configured to register a design and information related to the design; and a design profit adjustment unit configured to adjust an amount paid to a designer who has registered a design and a design fee for the registered design.

Further, the investor support module may comprise: an investment information inquiry unit configured to provide investment information on the registered design; an investment unit configured to select among the registered designs and proceed with the funding; a refund unit configured to provide a refund opportunity on the amount funded for the registered design; and an investment profit adjustment unit configured to calculate the investment profit and pay it to the investor, wherein the investment unit includes an investment amount input unit configured to fund the registered design according to the investor's input without restricting the limit of the amount to be funded, and wherein the refund unit includes a refund option selection unit configured to provide a refund opportunity wherever the profit rate decreases by a pre-input specific profit rate drop value.

Further, the apparatus for providing design crowdfunding platform may further comprise a producer support module configured to proceed with a production procedure of the registered design; and a consumer support module configured to display commodity information of a product to which the registered design has been applied and proceed with a purchase procedure.

In order to achieve the above object, according to another embodiment of the present invention, there can be provided a design crowdfunding system comprising: the above-mentioned apparatus for providing design crowdfunding platform; a designer terminal communicatively coupled to the apparatus for providing design crowdfunding platform; and an investor terminal communicatively coupled with the apparatus for providing design crowdfunding platform.

In order to achieve the above object, according to another embodiment of the present invention, there can be provided a method for providing design crowdfunding platform comprising: a step of registering a design and starting funding through a designer support module; and a step of proceeding with the started funding and adjusting the investment profit.

Further, the step of registering a design and starting funding may include a step of registering a design and information related to the design; and a step of adjusting the contract price and design fee of the registered design.

Further, the step of proceeding with the started funding and adjusting the investment profit comprises: a step of providing investment information on the registered design; a step of selecting among the registered design and proceeding with the funding; a step of providing a refund opportunity on the amount funded for the registered design; and a step of calculating the amount of the investment profit and paying it to the investor, and the step of selecting among the registered design and proceeding with the funding comprises a step of funding the registered design according to the input of the investor without restricting the limit of the amount to be funded, and the step of providing a refund opportunity on the amount funded for the registered design may comprises a step of providing a choice of whether or not to refund whenever the profit rate decreases by a specific profit rate drop value.

Further, the method for providing design crowdfunding platform may further comprise a step of proceeding with a production procedure of the registered design; and a step of displaying commodity information of a product to which the registered design has been applied and proceed with a purchase procedure.

In order to achieve the above technical objects, according to yet another embodiment of the present invention, there can be provided a computer readable recording medium on which a computer program for executing the method is recorded.

### Advantageous Effects

According to a method for providing design crowdfunding platform and an apparatus and system therefor according to one embodiment of the present invention, not only companies but also individual designers can easily register design products and raise funds, and individual designers can receive provision of the surplus money other than expenses for design product development and production, and the like, because there being no limit on the fund-raising amount, thereby earning a large amount of profit.

Also, according to a method for providing design crowdfunding platform and an apparatus and system therefor according to another embodiment of the present invention, investors can confirm a large number of registered design products and information related to the design products, and invest a desired investment amount, thereby obtaining the investment profit; because there is no limit of the fund-raising amount, as the fund-raising amount is higher, the sales yield per share of the design product, i.e., the investment profit rate, is lower, thereby providing a refund opportunity to the existing investors whenever the profit rate drops to a certain numerical ratio; and as the number of investors who are judged to have a low profit rate increases, the amount raised will naturally and more slowly grow, thereby preventing an abnormally low profit rate.

Further, according to a method for providing design crowdfunding platform and an apparatus and system therefor according to another embodiment of the present invention, the value of design can be evaluated through the fund-raised amount by a large number of investors to achieve collective intelligence in design evaluation; and the designer who created a design can make a higher profit as the money invested for the design is higher.

In addition, according to a method for providing design crowdfunding platform and an apparatus and system therefor according to yet another embodiment of the present invention, in order to avoid the inconvenience of designers having to separately search for and select producers of design products being funded, and having to find a separate sales route for design products, it is possible to connect a designer, an investor, a producer and a consumer who have raised funds through one platform, thereby allowing designers to easily expose their design products to producers and consumers, and easily providing the producer and consumer with an opportunity to produce and purchase products.

### BRIEF DESCRIPTION OF THE DRAWINGS

In order to more fully understand the drawings cited in the detailed description of the present invention, a brief description of each drawing is provided.

FIG. 1 is a schematic block diagram illustrating the design crowdfunding system 10 according to an embodiment of the present invention.

FIG. 2 is a schematic block diagram illustrating the designer support module 120 according to an embodiment of the present invention.

FIG. 3 is a schematic block diagram illustrating the investor support module 130 according to an embodiment of the present invention.

FIG. 4 is a schematic block diagram illustrating the producer support module 140 according to an embodiment of the present invention.

FIG. 5 is a schematic block diagram illustrating a consumer support module 150 according to an embodiment of the present invention.

FIG. 6 is a schematic block diagram illustrating the operation module 160 according to an embodiment of the present invention.

FIG. 7 is a schematic block diagram illustrating a mileage management module 170 according to an embodiment of the present invention.

FIG. 8 is a flowchart illustrating a method (S100) in which a designer registers a design and receives payment of profits through funding by utilizing the method for providing design crowdfunding platform according to an embodiment of the present invention.

FIG. 9 is a flowchart illustrating a method (S200) in which an investor receives payment of investment profit by using a method for providing design crowdfunding platform according to an embodiment of the present invention.

FIG. 10 is a flowchart illustrating a method (S300) of producing a registered design by a producer using the method for providing design crowdfunding platform according to an embodiment of the present invention.

FIG. 11 is a flowchart illustrating a method (S400) for a consumer to purchase a design product by utilizing the method for providing design crowdfunding platform according to an embodiment of the present invention.

### DETAILED DESCRIPTION OF THE EMBODIMENTS

Hereinafter, embodiments according to the present invention will be described with reference to the accompanying drawings. It should be noted that when reference numerals are added to components in each drawing, like reference numerals refer to like elements even if they appear in other drawings. In describing the embodiments of the present invention, if it is determined that a detailed description of a well-known function or configuration may unnecessarily obscure the gist of the present invention, the detailed description thereof will be omitted. In addition, embodiments of the present invention will be described below, but the technical idea of the present invention is not limited or restricted thereto and can be modified and implemented in various ways by those skilled in the art.

In this disclosure below, when one part (or element, device, etc.) is referred to as being ‘connected’ to another part (or element, device, etc.), it should be understood that the former can be ‘directly connected’ to the latter, or ‘indirectly connected’ to the latter via an intervening part (or element, device, etc.). Further, throughout the description, when a portion is referred to as “including” or “comprising” a certain component, it means that the portion can further include other components, without excluding the other components, unless otherwise stated. Further, in describing the components of the present disclosure, there may be terms used like the first, second, A, B, (a), and (b). These are solely for the purpose of differentiating one component from the other but not to imply or suggest the substances, order or sequence of the components.

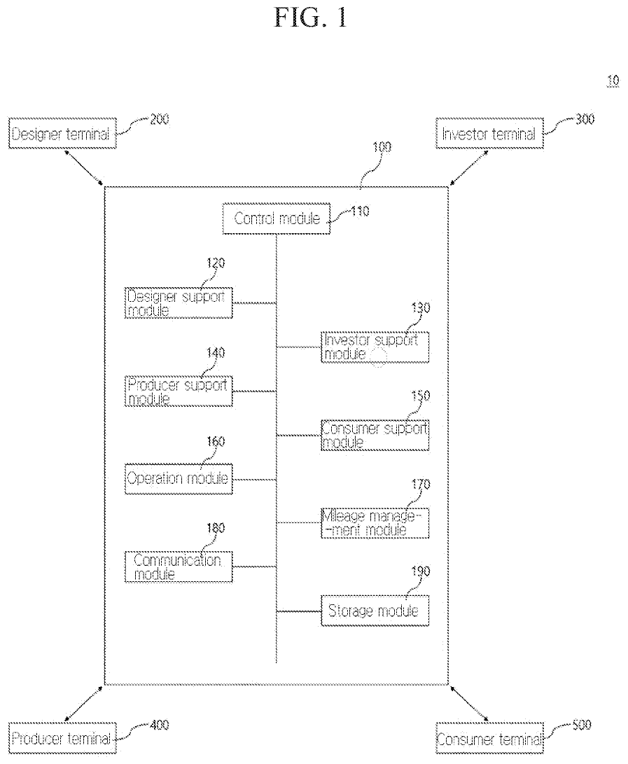

FIG. 1 is a schematic block diagram illustrating the design crowdfunding system 10 according to an embodiment of the present invention.

As shown in FIG. 1, the design crowdfunding system 10 according to an embodiment of the present invention may comprise a apparatus 100 for providing design crowdfunding platform, a designer terminal 200, an investor terminal 300, a producer terminal 400, a consumer terminal 500, and the like.

The designer terminal 200, the investor terminal 300, the producer terminal 400, and the consumer terminal 500 according to an embodiment of the present invention may be communicatively coupled with the apparatus 100 for providing design crowdfunding platform.

A apparatus 100 for providing design crowdfunding platform according to an embodiment of the present invention may include a control module 110, a designer support module 120, an investor support module 130, a producer support module 140, a consumer support module 150, an operation module 160, a mileage management module 170, a communication module 180, a storage module 190, and the like.

Further, the apparatus 100 for providing design crowdfunding platform according to an embodiment of the present invention corresponds to a self-computer program-based device produced and operated by an individual or private company, and may be referred to as an apparatus, equipment, server, platform, or the like depending on various expression methods in the relevant technical field.

For reference, the components 110, 120, 130, 140, 150, 160, 170, 180 and 190 of the apparatus 100 for providing design crowdfunding platform shown in FIG. 1 are merely illustrative components for explaining the operation, function and the like of the apparatus 100 for providing design crowdfunding platform according to an embodiment of the present invention. That is, it would be obvious that the apparatus 100 for providing design crowdfunding platform according to an embodiment of the present invention may further include components other than the illustrated components 110, 120, 130, 140, 150, 160, 170, 180, and 190 (e.g., a power supply unit, etc.).

The control module 110 according to an embodiment of the present invention can be configured to control the operation, function and the like of the components 120, 130, 140, 150, 160, 170, 180 and 190 constituting the apparatus 100 for providing design crowdfunding platform. In addition, the control module 110 according to an embodiment of the present invention can be configured to control the operation, function and the like of the components 120, 130, 140, 150, 160, 170, 180 and 190 constituting the apparatus 100 for providing design crowdfunding platform depending on commands received from the designer terminal 200, the investor terminal 300, the producer terminal 400, and the consumer terminal 500 through the communication module 180.

For reference, the control module 110 may be implemented as a processor, a microprocessor, a controller, a microcontroller, or the like.

According to one embodiment of the present invention, the apparatus 100 for providing design crowdfunding platform may include a designer support module 120 configured to register a design and start funding.

The designer support module 120 according to an embodiment of the present invention may be communicably coupled with the designer terminal 200 via a communication module 180, and may be configured so that the user of the designer terminal 200 uses the apparatus 100 for providing design crowdfunding platform. More specifically, the designer support module 120 according to an embodiment of the present invention interacts with the designer terminal 200 via the communication module 180 to allow the user of the designer terminal 200, i.e., the designer, to utilize the design crowdfunding system according to the present invention via the designer support module 120.

Further, the designer support module 120 according to an embodiment of the present invention may be configured to pay a design profit to a designer who has registered a design, and can be configured to change the sales price of the design. For reference, throughout this specification, the term ‘design profit’ can be understood to refer to all profits paid to designers who have registered designs out of the total fund-raising amount through funding for registered designs. For reference, the term “design profit” as used herein can be understood to refer to all profits paid to designers who have registered a design out of the total fund-raising amount through funding for the registered design. In addition, the designer can be defined as a concept that includes all of the person who created the design, the person who created a design and registered it in the apparatus 100 for providing design crowdfunding platform, and the person who acquired the right to the design, etc., which may, of course, include those who own rights to not only designs but also patents, utility models, trademarks, copyrighted works, etc.

According to one embodiment of the present invention, the apparatus 100 for providing design crowdfunding platform may include an investor support module 130 configured to proceed with funding started by the designer support module 120 and adjust the investment profit.

The investor support module 130 according to an embodiment of the present invention may be communicatively coupled with the investor terminal 300 via the communication module 180, and can be configured to allow the user of the investor terminal 300 to utilize the apparatus 100 for providing design crowdfunding platform. More specifically, the investor support module 130 according to an embodiment of the present invention interacts with the investor terminal 300 so that a user of the investor terminal 300, that is, an investor, can utilize the design crowdfunding system according to the present invention through the investor support module 130.

In addition, the investor support module 130 according to an embodiment of the present invention may be configured to allow an investor to select registered designs for funding, and may also be configured to refund the funded amount to the investor.

According to one embodiment of the present invention, the apparatus 100 for providing design crowdfunding platform may include a producer support module 140 configured to proceed with a production process of a registered design.

The producer support module 140 according to an embodiment of the present invention may be communicably coupled with the producer terminal 400 via the communication module 180, and may be configured so that the user of the producer terminal 400 can utilize the apparatus 100 for providing design crowdfunding platform. More specifically, the producer support module 140 according to an embodiment of the present invention interacts with the producer terminal 400 via the communication module 180, so that a user of the producer terminal 400, that is, a producer, can utilize the design crowdfunding system according to the present invention through the producer support module 140.

According to one embodiment of the present invention, the apparatus 100 for providing design crowdfunding platform may include a consumer support module 150 configured to display commodity information of a registered design and proceed with a purchase procedure.

The consumer support module 150 according to an embodiment of the present invention may be communicatively coupled with the consumer terminal 500 via the communication module 180, and can be configured so that the user of the consumer terminal 500 can utilize the apparatus 100 for providing design crowdfunding platform. More specifically, the consumer support module 150 according to an embodiment of the present invention interacts with the consumer terminal 500 via the communication module 180 so that the user of the consumer terminal 500, that is, the consumer, can utilize the design crowdfunding system according to the present invention via the consumer support module 150.

According to one embodiment of the present invention, the apparatus 100 for providing design crowdfunding platform may include an operation module 160 configured to provide various services necessary to operate the apparatus 100 for providing design crowdfunding platform, such as producer authentication, legal support, inventory management, product registration, operation profit generation, etc.

Further, the apparatus 100 for providing design crowdfunding platform according to an embodiment of the present invention may include a mileage management module 170 configured to convert a commodity having monetary value, such as amounts, costs, money, etc., provided by a designer, an investor, a producer, a consumer, etc., into mileage, or convert mileage into a commodity having monetary value.

The mileage management module 170 according to an embodiment of the present invention may be configured so that an investor purchases mileage with a commodity (e.g., money) having monetary value. The investor can fund the design registered as the mileage purchased through the mileage management module 170, and the designer can generate profits by receiving a certain percentage of the funded mileage and converting it into cash. Further, the mileage management module 170 according to an embodiment of the present invention may classify mileage into active or inactive mileage. For reference, the active mileage may be defined as mileage that can be converted into cash, and the inactive mileage may be defined as mileage that cannot be converted into cash.

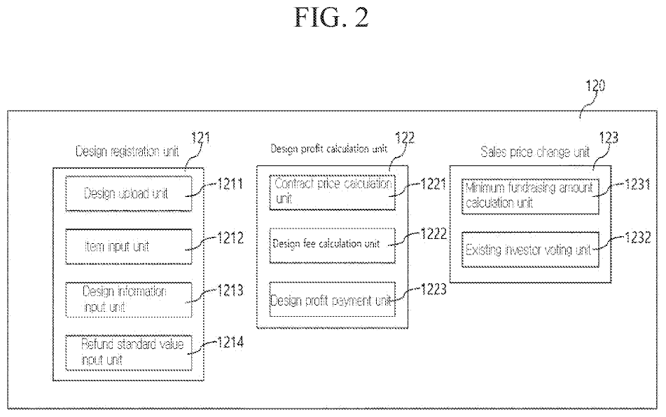

Each component of the apparatus 100 for providing design crowdfunding platform according to an embodiment of the present invention, that is, detailed configurations, purposes, functions and effect of the designer support module 120, the investor support module 130, the producer support module 140, the consumer support module 150, the operation module 160, and mileage management module 170 will be sequentially described in more detail in FIGS. 2 to 7, which will be described later.

According to one embodiment of the present invention, the apparatus 100 for providing design crowdfunding platform may include a communication module 180 configured to transmit and receive data with external devices such as the designer terminal 200, the investor terminal 300, the producer terminal 400, and the consumer terminal 500.

For reference, the communication module 180 is provided for direct connection with the outside or connection via a network, and may be a wired and/or wireless communication module 180. Specifically, the communication module 180 transmits data from the control module 110, the designer support module 120, the investor support module 130, the producer support module 140, the consumer support module 150, the operation module 160, the mileage management module 170, or the storage module 190 by wire or wirelessly, or receives data from the outside by wire or wirelessly, and thereby can be transmitted to the control module 110, the designer support module 120, the investor support module 130, the producer support module 140, the consumer support module 150, the operation module 160, or the mileage operation module 170, or can be stored in the storage module 190. The data may include content such as text, images, and videos.

Further, the communication module 180 can communicate via LAN, WCDMA (Wideband Code Division Multiple Access), LTE (Long Term Evolution), WiBro (Wireless Broadband Internet), RF (Radio Frequency) communication, Wireless LAN, Wi-Fi (Wireless Fidelity), NFC (Near Field Communication), Bluetooth, infrared communication, or the like. However, this is exemplary, and various wired and wireless communication technologies applicable in the art may be used according to the embodiments to which the present invention is applied.

According to one embodiment of the present invention, the apparatus 100 for providing design crowdfunding platform may include a storage module 190 configured to store data transmitted and received by each component of the apparatus 100 for providing design crowdfunding platform, that is, the control module 110, the designer support module 120, the investor support module 130, the producer support module 140, the consumer support module 150, the operation module 160, the mileage management module 170, the communication module 180, or the like, to and from external devices such as the designer terminal 200, the investor terminal 300, the producer terminal 400, and the consumer terminal 500.

In addition, the storage module 190 according to an embodiment of the present invention may store data related to a design registered by the designer and information related to the design, a sales price of the registered design, a minimum production quantity, a funding period, an inputted refund standard value, a minimum fund-raising amount calculation method, an investor voting method, a contract price, a design fee calculation method, a design item, a funded amount and mileage, an investment information related to the registered design, a profit rate, a method of calculating the profit rate, a method of calculating the refund amount, the amount of the refund paid, a method of calculating investment profit, investment profit paid, producible items, production information, proposed producer information, information on products sold, product purchase history, provided mileage, mileage management method, legal support method, active/inactive mileage, and the like.

For reference, the storage module 190 may be implemented in various types of storage devices capable of inputting and outputting information, such as HDD (Hard Disk Drive), ROM (Read Only Memory), RAM (Random Access Memory), EEPROM (Electrically Erasable and Programmable Read Only Memory), flash memory, CF (Compact Flash) card, SD (Secure Digital) card, SM (Smart Media) card, MMC (Multimedia) card or Memory Stick, etc., as known to those skilled in the art. The storage module 190 may be provided inside the apparatus 100 for providing design crowdfunding platform as shown in FIG. 1, or may be provided in a separate external device. Alternatively, the storage module 190 may be replaced by a web storage that performs a storage function on the Internet.

According to one embodiment of the present invention, the design crowdfunding system 10 may include a designer terminal 200, an investor terminal 300, a producer terminal 400, a consumer terminal 500, and the like which are communicatively coupled with the apparatus 100 for providing design crowdfunding platform. The designer terminal 200, the investor terminal 300, the producer terminal 400, the consumer terminal 500, and the like according to an embodiment of the present invention can be configured to transmit and receive data with the apparatus 100 for providing design crowdfunding platform.

For reference, the designer terminal 200, the investor terminal 300, the producer terminal 400, and the consumer terminal 500 may be referred to as a subscriber unit, a subscriber station, a mobile station, a mobile terminal, a remote station, a remote terminal, a mobile device, an access terminal, a terminal, a wireless communication device, a user agent, a user device, or a user equipment (UE). The access terminal may be a cellular telephone, a cordless telephone, a Session Initiation Protocol (SIP) telephone, a wireless local loop (WLL) station, a personal digital assistant (PDA), a handheld device with wireless connectivity capabilities, a computing device, or other processing device connected to a wireless modem.

For reference, the designer terminal 200, the investor terminal 300, the producer terminal 400, and the consumer terminal 500 according to an embodiment of the present invention are merely academically classified according to whether the user is a designer, investor, producer, or consumer who use the apparatus 100 for providing design crowdfunding platform, they may be the same device, different devices, or a plurality of devices.

Further, the design crowdfunding system 10 according to an embodiment of the present invention is configured so that the designers can register their designs and receive funding, the investors can also fund designs, and the producers and consumers can produce or purchase design products. Although this system is described throughout the specification, this is merely an exemplary embodiment for easy understanding of the present invention, and intangible rights such as patents, utility models, and copyrights as well as designs can be equally applied by the present invention.

Further, preferably, designs produced by the producer or purchased by the consumer through the design crowdfunding system 10 according to an embodiment of the present invention may include movable assets subject to independent transactions which is produced by applying the designs. Profits obtained from registration by designers or funding by investors may include all profits generated from commercial activities utilizing the design, as well as profits obtained from selling movable assets subject to independent transactions produced by applying the designs.

FIG. 2 is a schematic block diagram illustrating the designer support module 120 according to an embodiment of the present invention. According to one embodiment of the present invention, the designer support module 120 may include a design registration unit 121, a design profit adjustment unit 122, a sales price change unit 123, and the like.

The design registration unit 121 according to an embodiment of the present invention may be composed of a design upload unit 1211, an item input unit 1212, a design information input unit 1213, a refund standard value input unit 1214, and the like, and may be configured to register designs and information related to the designs. More specifically, the design registration unit 121 according to an embodiment of the present invention may be configured to register designs and information related to the designs in a list of designs exposed to investors, producers, and/or consumers, and thus to be funded, produced, and/or purchased. Further, the design registration unit 121 according to an embodiment of the present invention may be configured to register a design and start funding for the designs, and may be configured such that there is no limit on the amount of money that is funded.

Further, according to a further embodiment of the present invention, the design registration unit 121 may be configured to select and register a funding method as a loan type or a sponsor type at the time of design registration. When selected and registered as a loan type, the designer can receive a running guarantee or an incentive when a certain profit rate is achieved. Furthermore, also, according to further embodiments of the present invention, funding of registered designs can proceed not only by designers but also by investors.

The design upload unit 1211 according to an embodiment of the present invention may be configured to upload the designs of the user of the designer terminal 200, that is, the designer. The design uploaded by the design upload unit 1211 according to an embodiment of the present invention suffices as long as it expresses the form of the design, that is, the shape, shape, color, or combination thereof of the design, and is not limited to its format, such as photos and videos. Further, designs that are uploaded by the design upload unit 1211 according to an embodiment of the present invention to be funded, produced, or purchased may be exposed to an investor, a producer, a consumer, and the like. Further, the design referred to throughout the specification of the present invention can be defined as a concept including the design itself or goods or services to which the design has been applied.

The item input unit 1212 according to an embodiment of the present invention may be configured to allow the user of the designer terminal 200 to input items of a product or service to which a design has been applied. For example, if a designer enters T-shirts and neckties as design items to be funded, the investor, the producer, the consumer, etc. can decide whether to invest, produce, or consume by understanding the commodity to which the design has been applied as T-shirts or neckties. In this case, the design uploaded by the design upload unit 1211 according to an embodiment of the present invention may express the shape of a T-shirt or necktie, or may have the same shape and color as a character applied to a T-shirt or necktie.

The design information input unit 1213 according to an embodiment of the present invention may be configured to input information related to the design uploaded by the design upload unit 1211. More specifically, the related information inputted by the design information input unit 1213 according to an embodiment of the present invention may include information relating to a design fee due to running guarantee, a design fee due to basic cost, a sales price, a minimum production volume, and a funding period of the design (goods or service to which the design has been applied).

For reference, the design fee due to running guarantee may refer to a cost paid to the designer according to the profit generated by the design or the success of the business using the design. The design fee due to the basic cost may mean the minimum cost that can be basically paid to a designer who creates a design or transfers the right to a created design. In addition, the design fee can be defined as a concept including both a design fee due to a running guarantee and a design fee due to a basic cost.

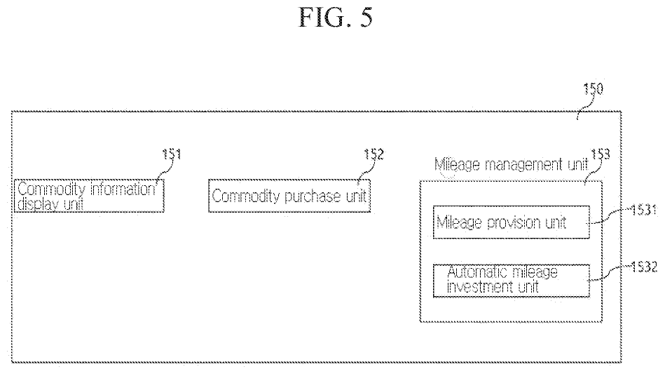

Further, information inputted by the design information input unit 1213 according to an embodiment of the present invention may be exposed to investors, producers, and/or consumers. Information exposed when an investor, a producer, and/or a consumer fund, produce, or purchase a design may be selectively exposed depending on whether or not the information is necessary for funding, production, or purchase. For example, among the information inputted by the design information input unit 1213 according to an embodiment of the present invention, the user of the investor terminal 300, that is, the investor, may be exposed to information related to the design fee, sales price, minimum production volume, and funding period, but information on the sales price may only be exposed on the consumer purchase page, and information about the funding period may not be exposed. However, when the mileage is provided to the consumer by the mileage provision unit 1531 (see FIG. 5) according to an embodiment of the present invention as the consumer completes the purchase, consumers can become investors who can participate in the funding of registered designs with the provided mileage. Thus, information about funding that is exposed to investors or information necessary for funding may be exposed to consumers who have been provided with mileage.

Further, according to a further embodiment of the present invention, the sales price may be determined by the original investor, but when the design is registered and funding starts, the sales price can be set as the average price of products to which the design has been applied. In addition, according to a further embodiment of the present invention, if the inputted sales price is unreasonably higher than the normal sales price, a new investor can take over the funding of the design and induce it at an appropriate price.

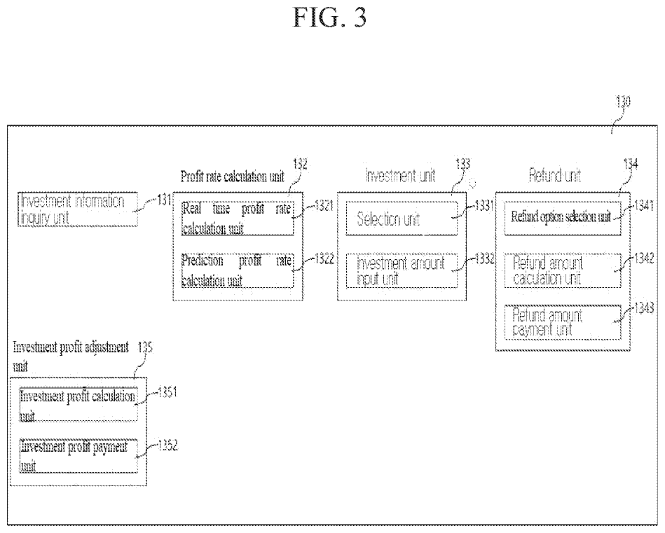

According to one embodiment of the present invention, the refund standard value input unit 1214 may be configured to input a specific profit rate drop value at which the investor is provided with a refund opportunity. As the amount of funding or investment mileage increases in the registered design, the investor's profit rate may decrease. If the profit rate decreases by a specific profit rate drop value (e.g., 0.01%) inputted by the refund standard value input unit 1214 according to an embodiment of the present invention, the refund unit 134 (see FIG. 3) may provide investors with an opportunity to refund the amount or investment mileage funded in the registered design.

Further, the specific profit rate drop value inputted by the refund standard value input unit 1214 according to an embodiment of the present invention may be exposed to the user of the investor terminal 300, that is, the investor. Therefore, the investor can determine whether or not to fund, the amount of funding, etc., using the specific profit rate drop of the registered design and the information input by the design information input unit 1213.

According to one embodiment of the present invention, the designer support module 120 may include a design profit adjustment unit 122 configured to adjust the contract price and design fee of the registered design. The design profit adjustment unit 122 according to an embodiment of the present invention may include a contract price calculation unit 1221, a design fee calculation unit 1223, a design profit payment unit 1223, and the like.

The contract price calculation unit 1221 according to an embodiment of the present invention may be configured to calculate a contract price paid to a designer who has registered a design. More specifically, the contract price calculation unit 1221 according to an embodiment of the present invention may be configured to calculate a contract price paid to a designer who has registered a design, by multiplying the mileage value of the total investment mileage funded in the design registered by the investor minus the required mileage, i.e. the surplus mileage, by a specific contract price payment value ratio.

In addition, the contract price calculation unit 1221 according to an embodiment of the present invention may be configured to calculate the contract price without limitation on the amount to be funded, that is, the limit of the total investment mileage of the funded design. More specifically, the contract price calculation unit 1221 according to an embodiment of the present invention may be configured to calculate the contract price with the total investment mileage funded during the funding period input by the design information input unit 1213, and the limit of the total investment mileage funded may not be restricted.

For reference, according to one embodiment of the present invention, investment mileage may be defined as mileage funded for a registered design of one investor, and the total investment mileage may be defined as the total sum of each investor's investment mileage. In addition, the total amount of investment mileage may be defined as the total sum of the investment mileage of each investor funded during the funding period inputted through the design information input unit 1213. In addition, the surplus mileage may be defined as total invested mileage minus the required mileage.

Further, the required mileage may be defined as the mileage corresponding to the minimum cost for commercialization or development, production and sales of the registered design, and the required mileage can be defined as the total sum of the development cost and the product of the minimum production volume of the registered design and the production price. In addition, the development cost can be defined as the total value of the design fee and production development cost based on the basic cost.

Further, the specific contract price payment value ratio may be defined as a specific numerical value for calculating the ratio paid to the designer from the mileage amount, which is obtained by subtracting the required mileage from the total investment mileage. For example, if the total investment mileage is 6 million won, the required mileage is 1 million won, and the specific contract price payment value ratio is 90%, the contract price paid to the designer can be calculated by a process in which the value of 4.5 million won in which the mileage value of 5 million won, which is obtained subtracting the required mileage of 1 million won from the total investment mileage of 6 million won, is multiplied by 90% of the specific contract price payment value ratio, is calculated as the contract price paid to the designer.

Therefore, since the apparatus 100 for providing design crowdfunding platform according to an embodiment of the present invention has no limit on the amount funded for registered designs, that is, the total amount of investment mileage. Thus, according to the apparatus 100 for providing design crowdfunding platform of an embodiment of the present invention, out of the funded amount, an individual designer can earn a lot of profit by receiving a surplus amount other than expenses for the development and production of products or services using design. The value of a registered design is evaluated by the amount funded by a large number of investors, thereby realizing collective intelligence in design evaluation. A designer who has a design with a high value or the designer who has determined that the value of the possessed design is high can register the design through the apparatus 100 for providing design crowdfunding platform according to an embodiment of the present invention, receive funding, and generate profits corresponding to the value of the design.

According to one embodiment of the present invention, the design fee calculation unit 1222 may be configured to calculate a design fee paid to a designer who has registered a design. As described above, the design fee can be defined as a concept including both a design fee due to a running guarantee and a design fee due to a basic cost, and the design fee due to the running guarantee can be defined as the cost paid to the designer according to the revenue generated by the design or the success of the business using the design. The design fee due to a basic cost can be defined as the minimum cost that can be basically paid to a designer who creates a design or acquires the right to a created design.

For reference, the design fee due to the running guarantee can also be defined as the amount provided to the designer out of the sales price per unit when the registered design is sold to consumers, and the design fee due the basic cost is the consideration for the effort of the designer who has created or acquired the design, and can also be defined as the minimum cost to be paid. The design fee, including both the design fee due to the running guarantee and the design fee due to the basic cost, can be inputted by the designer at an arbitrary cost through the design information input unit 1213 and exposed to an investor, or can be inputted at a cost averaged in the industry for the design item and exposed to the investor.

The design fee calculation unit 1222 according to an embodiment of the present invention may be configured to calculate a design fee paid to a designer who has registered a design by totaling the design fee due to the basic cost to the product of the design fee due to the running guarantee and the sales volume of the design. For example, if the design fee due to the running guarantee is 10 won, the design sales volume is 1000, and the design fee due to the basic cost is 100,000 won, the value of 110,000 won totaling the design fee of 100,000 won due to the basic cost and the value of 10000, which is obtained by multiplying the design sales quantity of 1000 by the design fee 10 won due to the running guarantee, can be calculated as a design fee paid to the registered designer.

According to an embodiment of the present invention, the design profit payment unit 1223 may be configured to pay design profit. More specifically, the design profit payment unit 1223 according to an embodiment of the present invention may be configured to pay a design profit corresponding to the total sum of the contract price calculated by the contract price calculation unit 1221 and the design fee calculated through the design fee calculation unit 1222 for the designer who has registered the design. For reference, the design profit can be defined as the total sum of the contract price and design fee.

According to one embodiment of the present invention, the designer support module 120 may include a sales price change unit 123 configured to change the sales price of a funded design. The sales price change unit 123 according to an embodiment of the present invention may include a minimum fund-raising amount calculation unit 1231, an existing investor voting unit 1232, and the like.

More specifically, the sales price change unit 123 according to an embodiment of the present invention may change the sales price or create funding by a new investor by calculating the minimum fund-raising amount and giving the existing investors the opportunity to vote, in response to requests for changes in sales from designers or investors or requests for funding by new investors.

The minimum fund-raising amount calculation unit 1231 according to an embodiment of the present invention may be configured to calculate the minimum fund-raising amount by totaling the required mileage and the value, which is obtained by multiplying the total investment mileage by an offer value for the existing investor. For example, if the required mileage is 1 million won, the total investment mileage is 5 million won, and the offer value presented by the new investor to the existing investor is 110%, the value of 6.5 million won totaling the required mileage of 1 million won and the value 5.5 million won, which is obtained by multiplying the total investment mileage of 5 million won by the offer value 110%, can be calculated as the minimum fund-raising amount for changing the sales price or raising funds by new investors.

For reference, the offer value can be defined as a value concluded when a new investor makes a subscription to an existing investor and the existing investor accepts the offer.

Further, the existing investor voting unit 1232 according to an embodiment of the present invention may be configured to advance the approval or disapproval vote for the change in sales price or the funding by a new investor for existing investors. In the approval or disapproval vote by the existing investor voting unit 1232 according to an embodiment of the present invention, a specific approval ratio for changing the sales price or raising fund by a new investor can be pre-entered by the designer at the time of design registration or set by agreement of the investors.

In summary, the sales price change unit 123 according to an embodiment of the present invention calculates the minimum fund-raising amount by the minimum fund-raising amount calculation unit 1231, and advances the approval or disapproval vote for the change of sales to the existing investor or the funding by the new investor through the existing investor voting unit 1232 based on the calculated minimum fund-raising amount. If the approval vote exceeds a predetermined approval rate (for example, 70% or more), the sale of the funded design can be changed, or the fund can be raised by a new investor.

Further, according to a further embodiment of the present invention, the existing investor voting unit 1232 may be configured to grant voting rights in favor of each existing investor according to the share ratio of each existing investor's investment mileage out of the total amount of investment mileage.

When funding by a new investor is raised, the existing investor participates in the funding by the new investor, based on the amount which is obtained by multiplying his/her own investment mileage by a value (e.g., 150%) calculated for the increase for raising the minimum fund-raising amount. In addition, the refund unit 134 may provide the investor with a refund opportunity according to a specific profit rate input unit 1214 due to a change in profit rate.

FIG. 3 is a schematic block diagram illustrating the investor support module 130 according to an embodiment of the present invention.

According to one embodiment of the present invention, the investor support module 130 may include an investment information inquiry unit 131, a profit rate calculation unit 132, an investment unit 133, a refund unit 134, an investment profit adjustment unit 135, and the like. In addition, the investor support module 130 according to an embodiment of the present invention may be configured to proceed with the funding started by the designer support module 120 and adjust the investment profit.

The investor support module 130 according to an embodiment of the present invention may include an investment information inquiry unit 131 configured to provide investment information on registered designs. More specifically, the investment information inquiry unit 131 according to an embodiment of the present invention may be configured to provide investment information on the registered design to the user of the investor terminal 300, i.e., the investor, who has funded the registered design.

Investment information provided by the investment information inquiry unit 131 according to an embodiment of the present invention may include the sales price of the registered design, a minimum production quantity, a funding period, a required mileage, the total investment mileage, a real time profit rate, predicted profit rate, development cost, and the like. Further, the investment information provided by the investment information inquiry unit 131 according to an embodiment of the present invention may include information registered or inputted by the design registration unit 121 including the design information input unit 1213.

Therefore, the investor can determine whether or not to fund, the amount of funding, and the like by receiving the investment information of the registered design from the investment information inquiry unit 131 and inquiring the investment information.

The investor support module 130 according to an embodiment of the present invention may include a profit rate calculation unit 132 configured to calculate a profit rate of the design funded. Further, the profit rate calculation unit 132 according to an embodiment of the present invention may include a real time profit rate calculation unit 1321, a predicted profit rate calculation unit 1322, and the like.

The profit rate calculation unit 132 according to an embodiment of the present invention may be configured to calculate the profit rate by dividing the value of the sales price of the funded design minus the production price by the total investment mileage. More specifically, the real time profit rate calculation unit 1321 according to an embodiment of the present invention may be configured to calculate the real time profit rate by dividing the value of the sales price of the design currently funded minus the production price by the total current investment mileage. In addition, the predicted profit rate calculation unit 1322 according to an embodiment of the present invention may calculate the predicted profit rate by dividing the value of the sales price of the design funded by the investor minus the production price by the value which is obtained by totaling the current total investment mileage with the investment mileage to be funded by the investor.

For example, in the case of calculating the real time profit rate, if the sales price of the currently funded design is 10,000 won, the production price is 6,000 won, and the current total investment mileage is 6 million won, about 0.07%, which is a value converted into a percentage by dividing 4,000 won, which is the sales price of 10,000 won minus the production price of 6,000 won, by 6,000,000 won, which is the current total investment mileage, can be calculated as a real time profit rate. In addition, as a case of calculating the predicted profit rate, if the sales price of the design to be funded is 10,000 won, the production price is 6,000 won, the total amount of current investment mileage is 6 million won, and the investment mileage that the investor plans to fund is 1 million won, about 0.06%, which is a value converted into a percentage by dividing 4,000 won, which is the sales price of 10,000 won minus the production price of 6,000 won, by 7 million won, which is the total sum of the current total investment mileage of 6 million won and the investment mileage of 1 million won that the investor plans to fund, can be calculated as a predicted profit rate

The profit rate calculated by the profit rate calculation unit 132 according to an embodiment of the present invention can be calculated by dividing the value of the sales price of the design to be funded minus the production price by the total investment mileage, and the total investment mileage is not limited. Thus, as the total investment mileage is higher, the calculated profit rate may be lower. As the value of the design to be funded is higher, the total investment mileage by many investors may be higher. As a result, the profit rate may decrease, but the expected sales volume of the design to be funded may be high. Thus, despite the low profit rate, investors can expect high returns, and whenever the profit rate drops by a specific profit rate value, the refund unit 134 allows the investor to select whether or not to refund the investment mileage and receive the refund amount.

Further, the real time profit rate and/or predicted profit rate calculated by the profit rate calculation unit 132 according to an embodiment of the present invention may be provided to the investors via the investment information inquiry unit 131. Therefore, investors can receive investment information such as real-time profit rate or predicted profit rate of the design to be funded, and decide whether or not to fund, the amount of funding, and the like.

According to one embodiment of the present invention, the investor support module 130 may include an investment unit 133 configured to select and fund a design to be funded. Further, the investment unit 133 according to an embodiment of the present invention may include a selection unit 1331, an investment amount input unit 1332, and the like.

More specifically, the investment unit 133 according to an embodiment of the present invention may be configured to select a design in response to a request for selection of a design to be funded by an investor among registered designs, and fund the registered design according to a funding amount input from an investor.

The selection unit 1331 according to an embodiment of the present invention may provide a list of designs that are registered and fundable to the user of the investor terminal 300, that is, an investor, and may be configured to select a design in response to a request for selection of a design to be funded from an investor received via the communication module 180.

In addition, the investment amount input unit 1332 according to an embodiment of the present invention may be configured to provide an input window capable of inputting a funding amount to the user of the investor terminal 300, that is, the investor, and also may be configured to fund the registered design according to the funding amount input from the investor received via the communication module 180.

That is, the investor can select and fund a design to be funded from the designs registered through the investment unit 133 using the active mileage purchased with cash through the mileage management module 170.

Further, as mentioned above, since there is no restriction on the funding amount, that is, the total investment mileage limit, the investment amount input unit 1332 according to an embodiment of the present invention may be configured to fund a registered design according to the input funding amount or investment mileage without restriction to the input funding amount, that is, the investment mileage limit.

According to one embodiment of the present invention, the investor support module 130 may include a refund unit 134 configured to provide investors with a refund opportunity for the amount or investment mileage funded for a registered design. The refund unit 134 according to an embodiment of the present invention may include a refund option selection unit 1341, a refund calculation unit 1342, a refund payment unit 1343, and the like.

More specifically, the refund option selection unit 1341 according to an embodiment of the present invention may be configured to provide a refund option to the investor whenever the profit rate, more preferably the real time profit rate, decreases by the specific profit rate inputted by the refund standard value input unit 1214. That is, the refund option selection unit 1341 according to an embodiment of the present invention may be configured to provide a selection window capable of selecting a refund option to the investor terminal 300 via the communication module 180 whenever the profit rate decreases by the specific profit rate drop value inputted by the refund standard value input unit 1214.

Further, the refund amount calculation unit 1342 according to an embodiment of the present invention may be configured to calculate the refund amount to be refunded to the investor. More specifically, the refund amount calculation unit 1342 according to an embodiment of the present invention may be configured to calculate the refund amount whenever the profit rate decreases by a specific profit rate value inputted by the refund standard value input unit 1214 according to the increase in the total investment mileage, change in sales price, or increase in the total investment mileage due to fund-raising by new investors.

The refund amount calculation unit 1342 according to an embodiment of the present invention may be configured to calculate the refund amount as the total sum of the principal investment mileage and the additional refund amount. Further, the refund amount calculation unit 1342 according to an embodiment of the present invention may be configured such that the total sum of an investment mileage, which is the principal amount funded, and a value obtained by multiplying the investment mileage by a specific refund payment value ratio, and the total sum of the investment mileage and the value obtained by multiplying the investment mileage by a specific refund payment value ratio, are divided by the total sum of the total investment mileage and the value obtained by multiplying the total investment mileage by a specific refund payment value ratio, the resulting divided value is multiplied by a value obtained by subtracting the required mileage from the surplus mileage, that is, the total investment mileage, and the smaller value of the resulting multiplied value is multiplied by the number of opportunities and the correction value, thereby calculating the refund amount.

For example, if the investment mileage of investor A is 3 million won, the investment mileage of investor B is 7 million won, and thus the total amount of investment mileage is 10 million won, the specific refund payment ratio is 10%, and the required mileage is 1 million won, the refund amount of investor A can be calculated by a process in which the total sum 3.3 million won of an investment mileage 3 million won and a value of 300,000 won of multiplying the investment mileage of 3 million won by 10% of the specific refund payment value rate, and the total sum of 3.3 million won of an investment mileage of 3 million won and a value 300,000 won of multiplying the investment mileage of 3 million won by 10% of the specific refund payment value ratio, are divided by the total sum of the total investment mileage of 10 million won and the value of 1 million of multiplying the total investment mileage of 10 million won by 10% of the specific refund payment value ratio, the resulting divided value of 0.3 is multiplied by the value of 9 million won of subtracting the required mileage of 1 million from the surplus mileage, that is, the total investment mileage of 10 million, and the smaller value of the resulting multiplied value of 2.7 million is multiplied by the number of opportunity and the correction value, thereby calculating the refund amount.

The refund calculation unit 1342 according to an embodiment of the present invention may be configured to adjust the number of opportunity and the correction value so that additional refunds are paid to investors, within the scope of the amount that guarantees investor's investment mileage, that is, the investor's principal, and multiplies the surplus mileage by a specific refund payment value ratio.

For reference, the specific refund amount payment value ration may be defined as the numerical ratio remaining after subtracting a specific contract price payment value ratio from the total percentage of the surplus mileage. In addition, the additional refund amount may be defined as the amount remaining after subtracting the investment mileage, i.e., the investor's principal, from the refund amount.

The refund amount payment unit 1343 according to an embodiment of the present invention may be configured to pay the refund amount to the investor. More specifically, the refund amount payment unit 1343 according to an embodiment of the present invention may be configured to pay the refund amount calculated by the refund amount calculation unit 1342 to an investor who has selected to receive the refund amount through the refund option selection unit 1341.

The investor support module 130 according to an embodiment of the present invention may include an investment profit adjustment unit 135 configured to calculate an amount of investment return and pay it to the investor. In addition, the investment profit adjustment unit 135 according to an embodiment of the present invention may include an investment return calculation unit 1351, an investment return payment unit 1352, and the like.

The investment return calculation unit 1351 according to an embodiment of the present invention may be configured to calculate the amount of investment return of the investor. More specifically, the investment return calculation unit 1351 according to an embodiment of the present invention may be configured to calculate the investment profit by a process in which the value obtained by multiplying the sales price by the sales volume is multiplied by the profit rate and further multiplied by the value obtained by dividing the investment mileage by the total investment mileage.

For example, if the sales price is 10,000 won, the sales volume is 1000, the profit rate is 0.1%, the investment mileage is 3 million won, and the total investment mileage is 10 million won, the value of 10 million won of multiplying the sales price of 10,000 won by 1000 units sold, is multiplied by the value of 10,000,000 won of multiplying the sales price of 10,000 won by 1,000 units sold, is multiplied by a profit rate of 0.1%, and the obtained value is further multiplied by the value of 0.3 of dividing the investment mileage of 3 million won by the total investment mileage of 10 million won, and the resulting multiplied amount of 3,000 won can be calculated as the amount of investment return.

The investment return payment unit 1352 according to an embodiment of the present invention may be configured to pay the amount of investment return calculated by the investment return calculation unit 1351 to the investor. More specifically, the investment return payment unit 1352 according to an embodiment of the present invention may be configured to pay the amount of the calculated investment return to the user of the investor terminal 300, i.e., the investor, as active mileage.

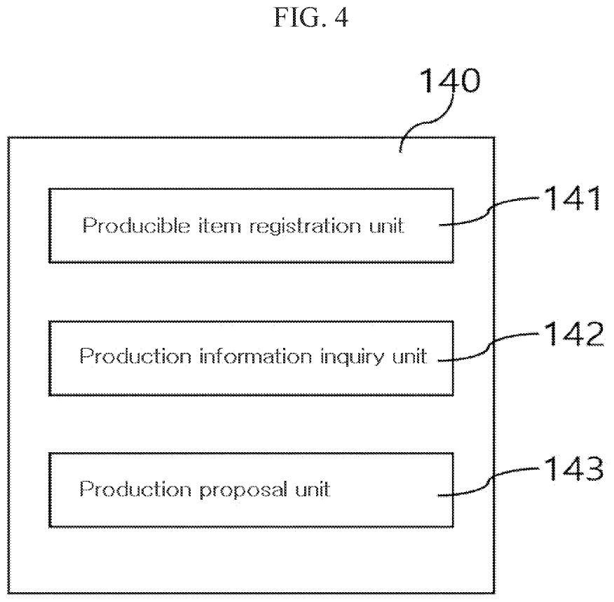

FIG. 4 is a schematic block diagram illustrating the producer support module 140 according to an embodiment of the present invention.

According to one embodiment of the present invention, the apparatus 100 for providing design crowdfunding platform may be configured to include a producer support module 140 configured to proceed with a production process of a registered design. The producer support module 140 according to an embodiment of the present invention may be composed of a producible item registration unit 141, a production information inquiry unit 142, a production proposal unit 143, and the like.

The producible item registration unit 141 according to an embodiment of the present invention may be configured so that a user, i.e., a producer, of the producer terminal 400 registers the producible items. More specifically, the producible item registration unit 141 according to an embodiment of the present invention may be configured to register a producible item in response to a request for registering a producible item received from the producer terminal 400 via the communication module 180, and to expose the item to designers and/or investors. Therefore, the designer or the investor can check the producible items registered by the producer through the producible item registration unit 141.

In addition, the production information inquiry unit 142 according to an embodiment of the present invention may be configured to provide production information of a registered design to a designer, an investor, and/or a producer. The production information provided by the production information inquiry unit 142 according to an embodiment of the present invention may include information such as a registered design item, a minimum production quantity, a sales price, and the like.

The production proposal unit 143 according to an embodiment of the present invention may be configured to propose production to a designer and/or an investor by inputting information such as material costs, production development costs, time required for production, etc. for a registered design by a producer. More specifically, the production proposal unit 143 according to an embodiment of the present invention may be configured to provide an input interface through which information such as material costs, production development costs, time required for production, etc. for a registered design can be inputted to the user of the producer terminal 400, that is, the producer, and may be configured to propose production by providing information such as material costs, production development costs, and time required for production for the registered design inputted by the producer to the designer and/or the investor.

For reference, the material cost can be defined as the material cost per design, the development cost can be defined as the total sum of the design fee and the production development cost due to the basic cost, and the required mileage can be defined as the value obtained by totaling the development cost and the product of the minimum production quantity and the production price of the registered design. Thus, the required mileage of the design to be funded can be used as production and development costs when producing the design of the producer.

The production proposal unit 143 according to a further embodiment of the present invention may be configured to propose production to a producer in response to a production proposal request from a designer and/or an investor. More specifically, the production proposal unit 143 according to a further embodiment of the present invention may be configured to propose production to a producer in response to a production proposal request from a designer and/or an investor received through the communication module 180. Therefore, the designer and/or the investor can check the registered producible item of the producer through the producible item registration unit 141 and request the producer to produce the registered design.

Further, the production proposal unit 143 according to a further embodiment of the present invention may be configured to propose production to a designer, an investor, and/or a producer when the design item registered by the item input unit 1212 matches with the producible item registered by the producible item registration unit 141. Therefore, the designer, investor and/or producer who has received production proposal can enter into a production contract by accepting the production proposal.

The designs produced through the producer support module 140 according to an embodiment of the present invention can be transferred to the operator side of the apparatus 100 for providing design crowdfunding platform, commercialized, and delivered to consumers who have purchased the product.

FIG. 5 is a schematic block diagram illustrating a consumer support module 150 according to an embodiment of the present invention.

The consumer support module 150 according to an embodiment of the present invention may be configured to display commodity information of a registered design and proceed with a purchase procedure. The consumer support module 150 according to an embodiment of the present invention may include a commodity information display unit 151, a commodity purchase unit 152, a mileage management unit 153, and the like.

According to one embodiment of the present invention, the consumer support module 150 may include a commodity information display unit 151 configured to provide commodity information of a registered design or a registered and produced design to a user of the consumer terminal 500, that is, a consumer. More specifically, the commodity information display unit 151 according to an embodiment of the present invention can be configured to provide commodity information of a registered design or a registered and generated design to the consumer terminal 500 through the communication module 180, and display commodity information on the on the display of the consumer terminal 500 or the like.

The consumer support module 150 according to an embodiment of the present invention may include a commodity purchase unit 152 configured to allow a consumer to purchase a product corresponding to commodity information provided or displayed by the commodity information display unit 151. More specifically, the commodity purchase unit 152 according to an embodiment of the present invention may be configured to provide a purchase window for a product corresponding to the commodity information provided or displayed by the commodity information display unit 151 to the user of the consumer terminal 500, that is, the consumer, and may be configured to purchase a product in response to a purchase request from a consumer.

For reference, the product purchase unit 152 according to an embodiment of the present invention may be configured to request production from a producer in response to a purchase request from a consumer of a registered design, or may be configured to purchase a product according to a commodity purchase request from a consumer of a registered and produced design.

The consumer support module 150 according to an embodiment of the present invention may include a mileage management unit 153 configured to provide mileage to a consumer who purchases a design and to fund the design with the mileage. The mileage management unit 153 according to an embodiment of the present invention may include a mileage provision unit 1531, an automatic mileage investment unit 1532, and the like. In addition, the mileage management unit 153 according to an embodiment of the present invention may be configured to ensure mileage blockchain to enhance security.

The mileage provision unit 1531 according to an embodiment of the present invention may be configured to provide mileage to consumers who purchase designs. More specifically, the mileage provision unit 1531 according to an embodiment of the present invention may be configured to provide mileage to consumers who purchase products through the commodity purchase unit 152.

The mileage provided to the consumer by the mileage provision unit 1531 according to an embodiment of the present invention may be inactive mileage. Therefore, the consumer can fund the provided inactive mileage to the registered design, convert the amount of investment return into active mileage and cash, thereby generating profits.

Further, the mileage provided to the consumer by the mileage provision unit 1531 according to an embodiment of the present invention may be paid at a specific ownership ratio (e.g., 10%) of the sales price. For example, if the sales price is 10,000 won and a specific ownership ratio of the sales price is 10%, the mileage provided to the consumer at the time of purchase may be provided as 1,000 won.

Further, according to a further embodiment of the present invention, the mileage provision unit 1531 may be configured to resell on other platforms or other sites on the condition that consumers do not provide mileage when purchasing in bulk or the consumer deducts some of the mileage provided.

The automatic mileage investment unit 1532 according to an embodiment of the present invention may be configured to automatically fund any registered design if the mileage provided to consumers through the mileage provision unit 1531 is not funded. In addition, the investment profit automatically funded and paid by the automatic mileage investment unit 1532 according to an embodiment of the present invention may be paid in inactive mileage.

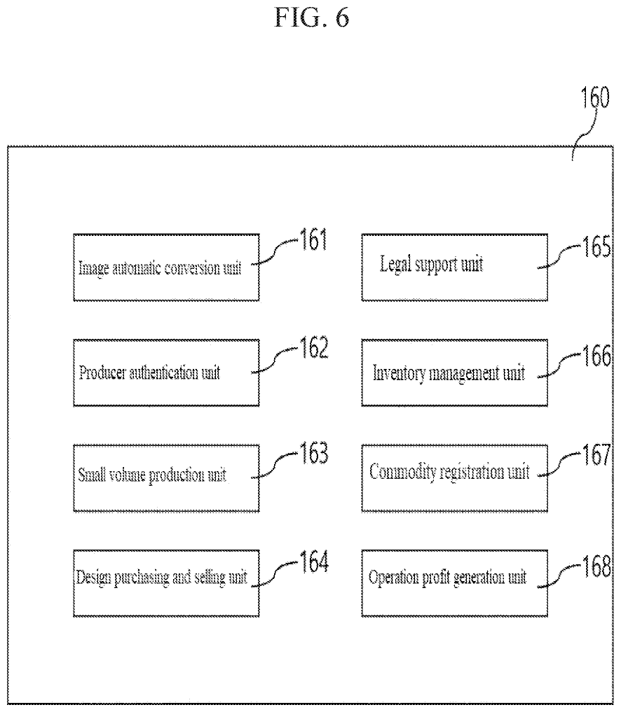

FIG. 6 is a schematic block diagram illustrating the operation module 160 according to an embodiment of the present invention. According to one embodiment of the present invention, the apparatus 100 for providing design crowdfunding platform may include an operation module 160 configured to provide various services necessary to operate the apparatus 100 for providing design crowdfunding platform, such as producer authentication, legal support, inventory management, product registration, operation profit generation, etc.

The operation module 160 according to an embodiment of the present invention may be composed of an image automatic conversion unit 161, a producer authentication unit 162, a small quantity production unit 163, a design purchasing and selling unit 164, a legal support unit 165, an inventory management unit 166, a commodity registration unit 167, an operation profit generation unit 168, and the like.

According to one embodiment of the present invention, the operation module 160 may include an automatic image conversion unit 161 configured to automatically convert a design into a mock-up image. The automatic image conversion unit 161 according to an embodiment of the present invention may be configured to automatically convert the design uploaded by the design upload unit 1211 into a mock-up image.

For example, if the design uploaded by the design upload unit 1211 is an abstract character or a 2D image that is not embodied in the product, the automatic image conversion unit 161 according to an embodiment of the present invention may automatically convert the design into a mock-up image of an item input by the item input unit 1212.

According to one embodiment of the present invention, the operation module 160 may include a producer authentication unit 162 configured to authenticate a producer. The producer authentication unit 162 according to an embodiment of the present invention may be configured to authenticate a user of the producer terminal 400, that is, a producer that satisfies a specific condition among producers. For example, specific conditions may include production plant size, production delivery credibility, and production of high quality products, and the like.

Therefore, a user, i.e., a designer, an investor, etc., of the apparatus 100 for providing design crowdfunding platform according to an embodiment of the present invention can produce designs or propose production through a producer authenticated by the producer authentication unit 162.

According to one embodiment of the present invention, the operation module 160 may include a small volume production unit 163 configured to produce the funded design in small volume as a producer. The small volume production unit 163 according to an embodiment of the present invention may be configured to produce small volume designs that are funded directly without going through the user of the producer terminal 400, that is, the producer. In addition, the design produced by the small volume production unit 163 according to an embodiment of the present invention may be produced or sold at a default price. For reference, the default price may include an average price the design of the corresponding item or a price inputted by an operator of the apparatus 100 for providing design crowdfunding platform, or the like.

According to one embodiment of the present invention, the operation module 160 may include a design purchasing and selling unit 164 configured to acquire rights to designs, register the designs, and fund them. Therefore, the design purchasing and selling unit 164 acquires and registers rights to famous or valuable designs for funding, thereby generating high profits.

According to one embodiment of the present invention, the operation module 160 may include a legal support unit 165 configured to provide legal services to users. i.e., designers, investors, producers and consumers, of the apparatus 100 for providing design crowdfunding platform.

For example, the legal support unit 165 according to an embodiment of the present invention may be configured to provide management services for intellectual property rights and copyrights related to design rights, patent rights, etc. relating to a designer's registered design. In addition, the legal support unit 165 according to an embodiment of the present invention may be configured to provide legal services through pre-contracted legal experts or the like.

In addition, the operation module 160 according to an embodiment of the present invention may include an inventory management unit 166 configured to manage inventory. More specifically, the inventory management unit 166 according to an embodiment of the present invention may be configured to manage inventory of products produced and sent to the operator of the apparatus 100 for providing design crowdfunding platform.

Further, the operation module 160 according to an embodiment of the present invention may include a commodity registration unit 167 configured to inspect the produced design and register it as a product displayed by the commodity information display unit 151, and may include an operation profit generation unit 168 configured to generate operation profits. More specifically, the operation profit generation unit 168 according to an embodiment of the present invention may be configured to generate operation profits through a cut-off value below the second decimal place of the exposed profit rate, advertisements, fees, mileage of expired or dormant accounts, and the like.

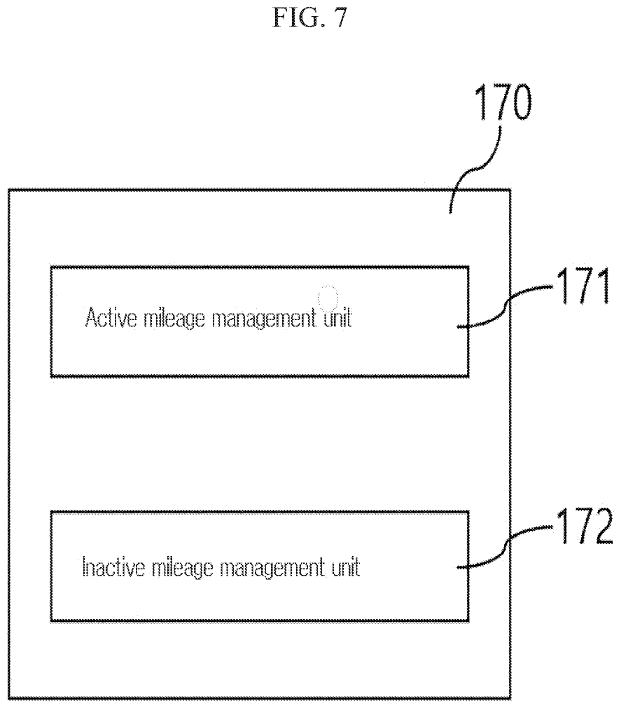

FIG. 7 is a schematic block diagram illustrating a mileage management module 170 according to an embodiment of the present invention.

A apparatus 100 for providing design crowdfunding platform according to an embodiment of the present invention may include a mileage management module 170 configured to convert goods having monetary value, such as amounts, costs and money, provided from designers, investors, producers, consumers, etc., or provided to designers, investors, producers, consumers, etc., into mileage, or convert mileage into goods having monetary value. In addition, the mileage management module 170 according to an embodiment of the present invention may be configured to convert and exchange goods having monetary value exchanged among designers, investors, producers, consumers, etc. into mileage.

The mileage management module 170 according to an embodiment of the present invention may include an active mileage management unit 171, an inactive mileage management unit 172, and the like.

The active mileage management unit 171 according to an embodiment of the present invention may be configured to convert goods (e.g., money) having monetary value provided by investors into active mileage. Also, the active mileage management unit 171 according to an embodiment of the present invention may be configured to pay the contract price and design fee paid to the designer as active mileage. Further, it may be configured to pay the amount of the refund to the investor and the amount of investment return to be paid as active mileage. In addition, it may be configured to pay in active mileage the amount of investment return that the consumer derives from funding the inactive mileage provided to the consumer when purchasing a product. Thus, designers, investors and consumers can cash in on the paid active miles to generate revenue.

The inactive mileage operation unit 172 according to an embodiment of the present invention may be configured to pay mileage provided to consumers as inactive mileage when a consumer purchases a product, and may also be configured to pay with inactive mileage the amount of investment return by automatically funding any registered design.

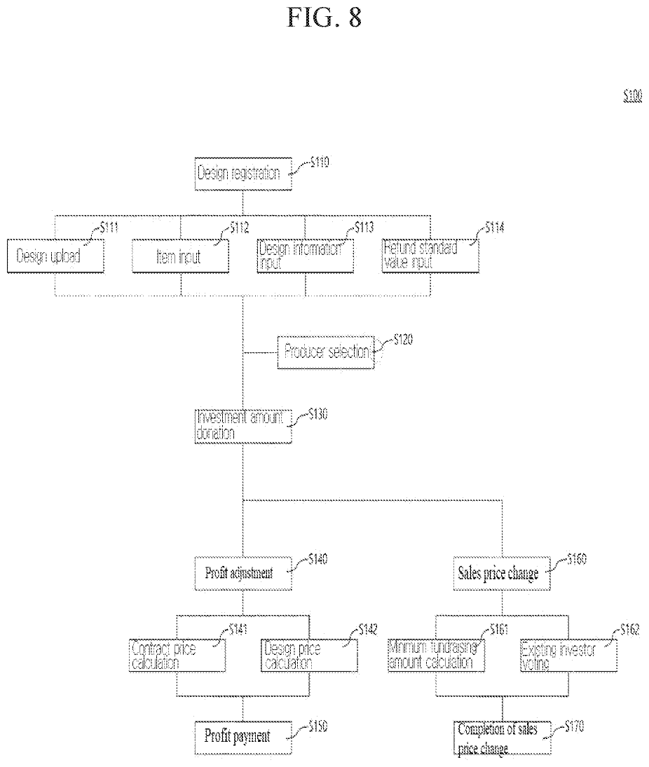

FIG. 8 is a flowchart illustrating a method (S100) in which a designer registers a design and receives payment of profits through funding by utilizing the method for providing design crowdfunding platform according to an embodiment of the present invention.

First, a step of registering a design and information related to the design (S110) may be performed. More specifically, the step (S110) of registering a design and information related to the design may include a step (S111) of uploading the design, a step (S112) of inputting the items of goods or services to which the design has been applied, a step (S113) of inputting information related to the design to be uploaded, a step (S114) of inputting a specific profit rate drop at which a refund opportunity is provided to the investor, and the like.

Then, the stage of proceeding with the started funding and adjusting the investment profit may go through a step of raising the investment amount by the investor, that is, a step (S130) of funding the registered design, and may also go through a step (S120) of selecting a producer who will produce the registered design before going through the step (S130) of funding the registered design by the investor. For reference, according to another embodiment of the present invention, a step (S120) of selecting a producer may be performed after the step (S140) of adjusting the design profit.

After the step (S130) of funding the design registered by the investor, a step of adjusting the design profit (S140) can be performed. The step (S140) of adjusting the design profit may include a step (S141) of calculating a contract price and a step (S142) of calculating a design fee. Then, a step (S150) of paying the design profit to the designer may be performed.

On the other hand, the step (S160) of changing the sales price may be started while the step (S130) of funding the registered design is in progress. The step (S160) of changing the sales price may include a step (S161) of calculating a minimum fund-raising amount and a step (S162) of advancing an approval or disapproval vote for the existing investor. After that, the change in sales price (S170) may be completed through a step (S161) of calculating the minimum fund-raising amount and a step (S162) of advancing an approval or disapproval vote for the existing investors.

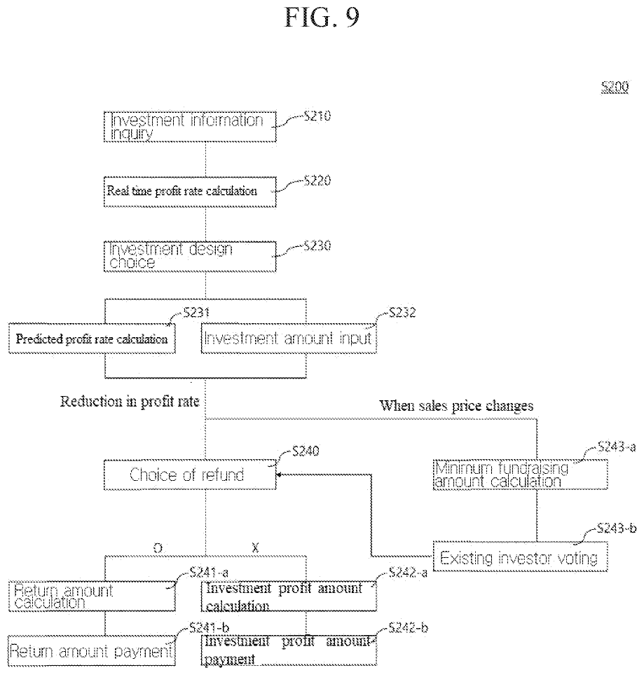

FIG. 9 is a flowchart illustrating a method (S200) in which an investor receives payment of investment profit by using a method for providing design crowdfunding platform according to an embodiment of the present invention.

First, a step (S210) of providing investment information on the registered design so that the investor inquires the investment information may be performed. After that, a step (S220) of calculating the real time profit rate may be performed, and then, a step (S230) of providing a list of designs that are registered and funded to investors, and selecting a design in response to a request for selection of a design to be funded from an investor.

The step (S230) of selecting a design may include a step (231) of calculating a predicted profit rate and an investment amount input, that is, a step (S232) of funding the registered design according to the funding amount input by the investor, or may proceed these steps at the same time.

After that, as the funding progresses, as the amount of funding for the registered design, that is, the total investment mileage increases, the profit rate decreases. Thus, a step (S240) of providing the investor with a choice of whether or not to refund may proceed.

If the refund is in progress, after the step (S241-a) of calculating the refund amount (S241-b), the refund amount may be paid to the investor (S241-b). In contrast, if a refund does not proceed, after the step (S242-a) of calculating the amount of investment profit, the amount of investment profit can be paid to the investor (S242-b). On the other hand, when the sales price is changed or when funding is raised by a new investor, the sales price is changed or funding by a new investor can be raised through the step (S243-a) of calculating the minimum fund-raising amount and the step (S243-b) of advancing an approval or disapproval vote for the existing investors. As the profit rate decreases according to the change in sales price or the amount of funding by new investors, a step (S240) of providing the investor with a choice of whether or not to refund may proceed.

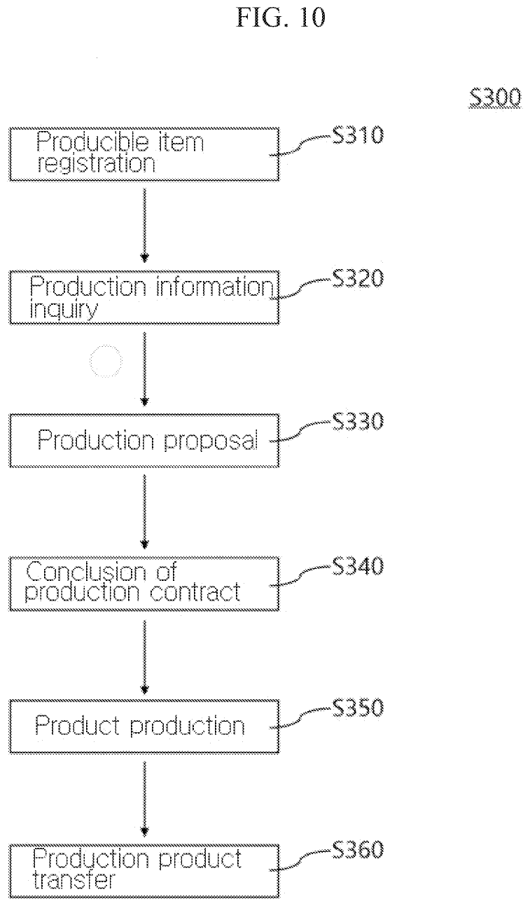

FIG. 10 is a flowchart illustrating a method (S300) of producing a registered design by a producer using the method for providing design crowdfunding platform according to an embodiment of the present invention.

First, a step (S310) of registering a producible item may be performed, and then a step (S320) of providing production information to designers, investors, and/or producers to inquire production information may be performed.

Then, a step in which the producer proposes production of the design to the designer and investor or the designer and investor to the producer may proceed, and a production contract may be concluded by accepting the production proposal (S340).

After that, as the production contract is concluded, the product to which the design has been applied can be produced (S350), and the produced product may be delivered to the operator side (S360).

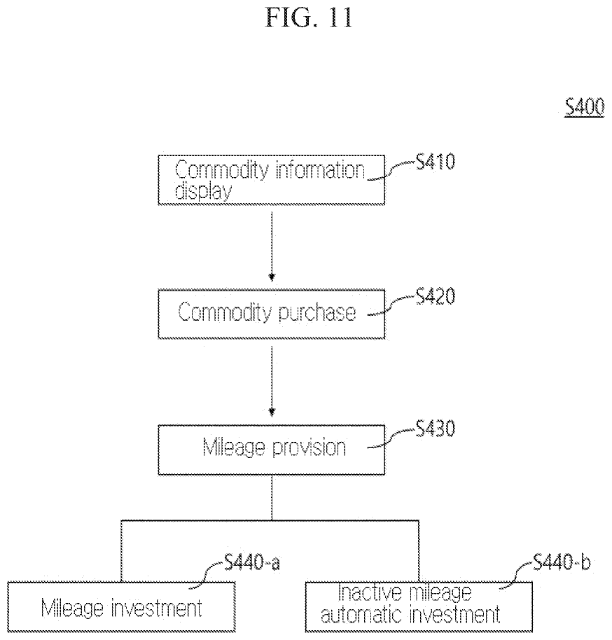

FIG. 11 is a flowchart illustrating a method (S400) for a consumer to purchase a design product by utilizing the method for providing design crowdfunding platform according to an embodiment of the present invention.

First, a step (S410) of displaying commodity information to the consumer may proceed. After that, a step (S420) of purchasing a product in response to a purchase request from a consumer (S420) may proceed, and a step (S430) of providing mileage to consumers who have purchased products may proceed.

A step (S440-a) of funding a registered design using the mileage provided to consumers according to the purchase of the product may be performed, or if the provided mileage is not funded to a registered design for a specific period of time, a step (S440-b) of providing the provided mileage is automatically funded in any registered design may be performed.

As described above, according to a method for providing design crowdfunding platform and an apparatus and system therefor of an embodiment of the present invention, not only companies but also individual designers can easily register design products and raise funds, and there is no limit on the fund-raising amount, so individual designers can earn a lot of profit by receiving surplus money other than the cost for the development and production of design products.

Also, according to a method for providing design crowdfunding platform and an apparatus and system therefor of an embodiment of the present invention, the investors can check a large number of registered design products and information related to the design products, invest a desired investment amount, and obtain the investment profit; which can provide a refund opportunity to the existing investor whenever the profit rate drops to a certain numerical ratio because the limit of the fund-raising amount is not restricted, so that the higher the fund-raising amount, the lower the sales yield per share of the design product, that is, the rate of investment return; and which can prevent an abnormally low rate of profit, as the more investors who are judged to have a low rate of profit, the more slowly the amount raised will naturally grow.

In addition, according to a method for providing design crowdfunding platform and an apparatus and system therefor of an embodiment of the present invention, the invention can achieve collective intelligence in design evaluation by evaluating the value of design through the fund-raised amount by a large number of investors; and allow the designer who created the design to make a higher profit for the design with a large amount of money invested.

Further, according to a method for providing design crowdfunding platform and an apparatus and system therefor of an embodiment of the present invention, a designer, an investors, a producer, and a consumer who have raised funds are connected through one platform, so that designers do not have to separately search and select the producer of the design products to be funded, or find separate sales channels for design products, thereby allowing designers to easily expose their design products to producers and consumers, and easily providing the producer and consumer with an opportunity to produce and purchase products.

On the other hand, various embodiments described herein may be implemented by hardware, middleware, microcode, software, and/or combinations thereof. For example, various embodiments may be implemented in one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions presented herein, or a combinations thereof.

Further, for example, various embodiments may be recorded or encoded on a computer-readable medium containing instructions. Instructions recorded or encoded on a computer-readable medium can cause a programmable processor or other processor to perform a method, for example when the instructions are executed. Computer-readable media includes computer storage media, the computer storage media may be any available media that can be accessed by a computer. For example, such computer-readable media may include RAM, ROM, EEPROM, CD-ROM or other optical disk storage media, magnetic disk storage media or other magnetic storage devices.

Such hardware, software, firmware, and the like may be implemented within the same device or within separate devices to support the various operations and functions described herein. In additional, the elements, units, modules, components, and the like, that are described as “-unit” herein may be realized together or separately as discrete but interoperable logic devices. Depiction of different features as modules, units, and the like are intended to highlight different functional embodiment and does not necessarily imply that they must be realized by separate hardware or software components. Rather, functionality associated with one or more modules or units may be performed by separate hardware or software components or integrated within common or separate hardware or software components.

Although actions are depicted in the drawings in a particular order, it should not be understood that these actions need to be performed in the particular order shown, or in a sequential order shown, or that all actions depicted need to be performed in order to achieve a desired result. In some circumstances, multitasking and parallel processing may be advantageous. Moreover, the division of various components in the above embodiments should not be understood as requiring such division in all embodiments, and it should be understood that the described components may generally be integrated together into a single software product or packaged in multiple software products.

The preferred embodiments have been disclosed in the drawings and specification as described above. Although specific terms have been used herein, they are only used for the purpose of describing the present invention and are not used to limit the meaning or limit the scope of the present invention defined in the claims. Therefore, those of ordinary skill in the art will appreciate that various modifications and equivalent other embodiments can be made therefrom. Therefore, the true technical scope of protection of the present invention should be determined by the technical spirit and idea of the appended claims.

1. An apparatus 100 for providing design crowdfunding platform comprising:
a designer support module 120 configured to register a design and start funding; and
an investor support module 130 configured to proceed with the funding started by the designer support module 120, and adjust the investment profit,
wherein the investor support module 130 comprises,
an investment information inquiry unit 131 configured to provide investment information on the registered design;
a profit rate calculation unit 132 configured to calculate a profit rate by dividing a value of subtracting a production price from a sales price of a product with a design that has been recorded and started funding, by a total investment mileage,
an investment unit 133 configured to select among the registered designs and proceed with the funding;
a refund unit 134 configured to provide an opportunity to refund the amount funded for the registered design; and
an investment profit adjustment unit 135 configured to adjust the investment profit and pay it to the investor,
wherein the investment unit 133 includes an investment amount input unit 1332 configured to fund the registered design according to the investor's input without restricting the limit of the amount to be funded, and
wherein the refund unit 134 includes a refund option selection unit 1341 configured to provide a refund opportunity wherever the profit rate decreases by a pre-input specific profit rate drop value.

2. The apparatus 100 for providing design crowdfunding platform of claim 1, wherein:
the designer support module 120 comprises,
a design registration unit 121 configured to register the design and information related to the design; and
a design profit adjustment unit 122 configured to adjust an amount paid to a designer who has registered a design, and a design fee for the registered design.

3. The apparatus 100 for providing design crowdfunding platform of claim 1, further comprising:
a producer support module 140 which includes: a producible item registration unit 141 configured to register producible items of a producer; a production information inquiry unit 142 configured to provide a designer, an investor, or a producer with production information of a product to which the registered design has been applied; and
a production proposal unit 143 configured to receive input of material cost, development cost for production, and production required time information of the product to which the registered design has been applied from the producer, and to propose production by providing the input information to the designer or the investor; and
a consumer support module 150 configured to display commodity information of a product to which the registered design has been applied and proceed with a purchase procedure.

4. A design crowdfunding system 10 comprising:
the apparatus 100 for providing design crowdfunding platform as defined in claim 1;
a designer terminal 200 communicatively coupled with the apparatus 100 for providing design crowdfunding platform; and
an investor terminal 300 communicatively coupled with the apparatus 100 for providing design crowdfunding platform.

5. A method for providing design crowdfunding platform, which is realized by an apparatus for providing design crowdfunding platform, the method comprising:
a step of registering a design and starting funding through a designer support module; and
a step of proceeding with the started funding and adjusting the investment profit through an investor support module,
wherein the step of proceeding with the started funding and adjusting the investment profit through an investor support module comprises,
a step of providing investment information on the registered design through an investment information inquiry unit;
a step of selecting among the registered design and proceeding with the funding through an investment unit;
a step of dividing a value of subtracting the production price from the sales price of the product with a design that has been registered and started funding, by the total investment mileage through a profit rate calculation unit, thereby calculating a profit rate;
a step of providing an opportunity to refund the amount funded for the registered design through the refund unit; and
a step of calculating the investment profit and paying it to the investor through an investment profit adjustment unit,
wherein the step of selecting among the registered design and proceeding with the funding s through an investment unit comprises,
a step of funding the registered design according to the input of the investor without restricting the limit of the amount to be funded through an investment amount input unit,
wherein the step of providing an opportunity to refund the amount funded for the registered design through the refund unit comprises,
a step of providing a refund opportunity whenever the profit rate decreases by a pre-entered specific profit rate drop value.

6. The method for providing design crowdfunding platform of claim 5, wherein:
the step of registering a design and starting funding through a designer support module comprises:
a step of registering a design and information related to the design through the design registration unit; and
a step of adjusting the amount to be paid to a designer who has registered a design and the design fee of the registered design through the design profit adjustment unit.

7. The method for providing design crowdfunding platform of claim 5, further comprising:
a step of registering producible items of a producer though a producible item registration unit;
a step of providing production information of the product to which the registered design has been applied to the designer, the investor, or the producer through a production information inquiry unit;
a step of receiving information on the material cost, development cost for production, and the time required for production of the product to which the registered design has been applied from the producer and providing the input information to the designer or the investor through a production proposal unit, thereby proposing the production; and
a step of displaying the commodity information of the product to which the registered design has been applied and proceeding with the purchase procedure through a consumer support module.

8. A computer readable recording medium on which a computer program for executing the method as defined in claim 5 is recorded.

9. A computer readable recording medium on which a computer program for executing the method as defined in claim 6 is recorded.

10. A computer readable recording medium on which a computer program for executing the method as defined in claim 7 is recorded.
